(19) United States
(12) Patent Application Publication
(10) Pub. No.: US 2012/0169584 A1
(43) Pub. Date: Jul. 5, 2012

(54) AIR CONDITIONING APPARATUS AND A METHOD FOR CONTROLLING AN AIR CONDITIONING APPARATUS

(76) Inventor: Dongbum HWANG, Changwon City (KR)

(21) Appl. No.: 13/302,029

(22) Filed: Nov. 22, 2011

(30) Foreign Application Priority Data
Jan. 4, 2011 (KR) 10-2011-0000432

(51) Int. Cl. G09G 5/00

(52) U.S. Cl. 345/156

(57) ABSTRACT

An air conditioning apparatus and a method for controlling an air conditioning apparatus are provided. The method may include turning on an image capturing device provided in an indoor device; recognizing a gesture identifier moved in front of the image capturing device; inputting a gesture according to a movement of the gesture identifier; analyzing the input gesture; extracting operating condition(s) corresponding to the analyzed gesture; and driving the indoor device according to the extracted operating condition(s).

### CROSS-REFERENCE TO RELATED APPLICATION(S)

The present application claims priority to Korean Patent Application No. 10-2011-0000432, filed on Jan. 4, 2011, which is herein incorporated by reference in its entirety.

### BACKGROUND

### 1. Field

An air conditioning apparatus and a method for controlling an air conditioning apparatus are disclosed herein.

### BRIEF DESCRIPTION OF THE DRAWINGS

Embodiments will be described in detail with reference to the following drawings in which like reference numerals refer to like elements, and wherein:

FIG. 1 is a schematic diagram of a network system according to an embodiment;

FIG. 2 is a block diagram illustrating radio communication between a mobile terminal, an indoor device, and a smart meter in a network system according to an embodiment;

FIG. 3 is a flow chart for a method for controlling an indoor device of an air conditioning apparatus by detecting a gesture identifier according to an embodiment;

FIG. 4 is a flow chart of a gesture input process according to an embodiment;

FIG. 5 is a flow chart of a gesture analysis process according to an embodiment;

FIGS. 6A-6D are explanatory diagrams visually illustrating the gesture analysis process of FIG. 5;

FIGS. 7A-7G are diagrams illustrating shapes of a gesture identifier trajectory for operating condition(s) in a method for controlling an indoor device of an air conditioning apparatus according to an embodiment;

FIG. 8 is a flow chart for a method for controlling an indoor device of an air conditioning apparatus, based on power amount information received from a smart meter; and

FIGS. 9 to 12 are diagrams illustrating contents of a notification information output based on information transmitted from a smart meter.

### DETAILED DESCRIPTION

In the following detailed description of embodiments, reference is made to the accompanying drawings that form a part hereof, and in which is shown by way of illustration specific embodiments. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense, and the scope of the invention is defined only by the appended claims.

Hereinafter, embodiments will be described with reference to the accompanying drawings.

In general, an air conditioning apparatus is a consumer electronic device that provides hot air or cold air into an indoor space by operation of a refrigerant cycle. In recent years, mobile terminals, such as smart phones, have been developed that can access the Internet to freely download documents, game programs, and/or document files, and perform them, together with making phone calls.

In addition, in recent years, home network systems have become very popular in newly-built apartments and homes. The home network system can control the operations of electrical appliances including consumer electronic devices installed in the home via the mobile terminal. Likewise, a variety of consumer devices, including an air conditioning apparatus, can be remotely controlled from a long distance, and thereby, ease of use has been greatly improved.

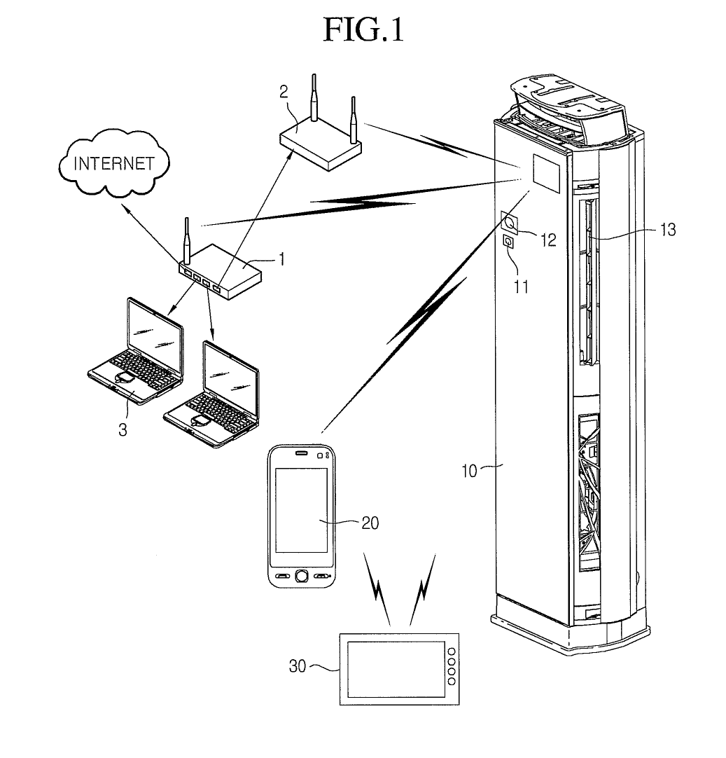

FIG. 1 is a schematic diagram of a network system according to an embodiment. Referring to FIG. 1, a network system according to an embodiment may include an indoor unit or device 10 of an air conditioning apparatus that supplies hot or cool air, a mobile terminal 20, which may be a smart phone capable of radio communication with the indoor device 10, and a wire and wireless router 1 and/or a wireless router 2 that provide Internet-communication between the mobile terminal 20 and the indoor device 10. In addition, the network system may further include a computer connected to the wire and wireless router 1 by wire and/or wireless communication.

Further, the network system may further include a smart meter 30 that transmits power consumption information of the indoor device 10 and/or the mobile terminal 20. The power consumption information may include information about fees per watt of power currently supplied to the indoor device 10, information about power amounts currently being consumed, and information about whether power amounts currently being consumed reach a predetermined peak value. In addition, the power consumption information may include all energy information related to a smart grid.

The mobile terminal 20 and the indoor device 10 each may be provided with a communication module for radio communication. The communication module may include a Bluetooth module, a Wi-Fi module, or a ZigBee module. The smart meter 30 may also be provided with a radio communication module, as mentioned above, that radio-communicates with the mobile terminal 20 and the indoor device 10. In addition, the indoor device 10 may be configured so that wire communication may be performed using a power line communication (PLC).

The indoor device 10 may be provided with an image capturing device 12, such as a camera, that captures an image of the user, such as an image of a user's palm, and a recorder 11 that records a voice of the user. The mobile terminal 20 may be also provided with an image capturing device and a recorder.

The mobile terminal 20 may communicate directly with the indoor device 10 by one-to-one communication through the communication module for radio communication. Accordingly, the user may input operating condition(s) through a control panel mounted on the indoor device 10, or through the mobile terminal 20. When the operating condition(s) are input through the mobile terminal 20, the input operating condition(s) may be transmitted to the indoor device 10 through the communication module, and, for example, a speed of an indoor fan or an angle of a wind direction adjustment device 13 may be set or changed according to the transmitted operating condition(s).

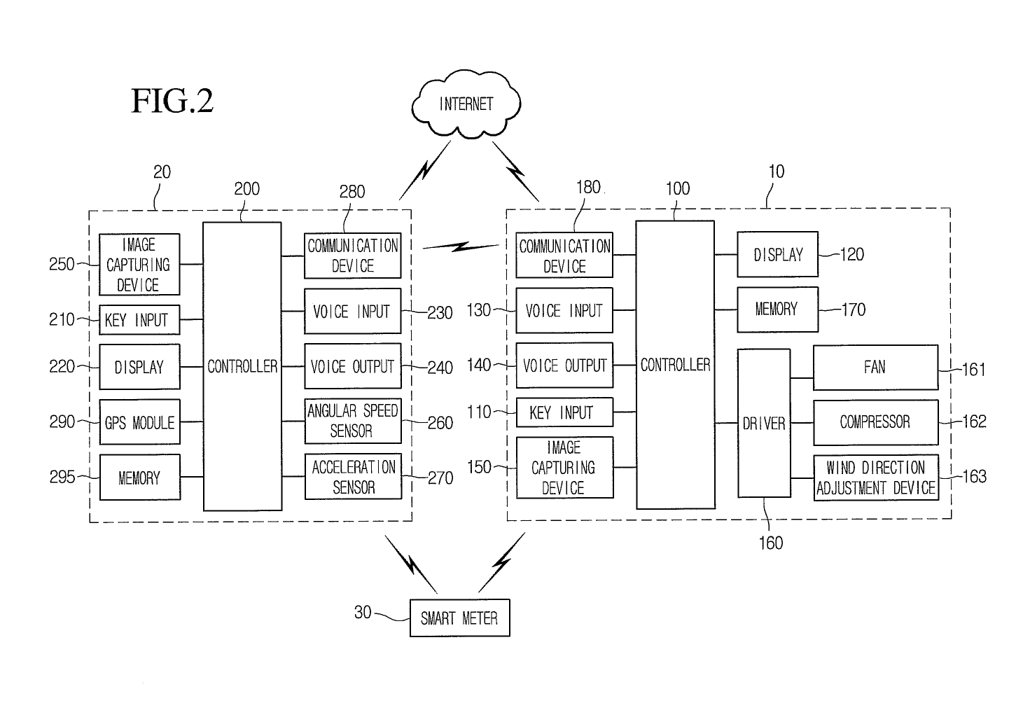

FIG. 2 is a block diagram illustrating radio communication between a mobile terminal, an indoor device, and a smart meter in a network system according to an embodiment. Referring to FIG. 2, in the configuration of the network system according to this embodiment, the mobile terminal 20 may include the recently introduced smart phone or tablet PC.

In more detail, the mobile terminal 20 may include a controller 200, a key input 210 that receives input of specific commands or information to the controller 200, a display 220 that displays a state of the mobile terminal 20 or an operation state of the indoor device 10, a voice input 230 that receives input of/records a user's voice, a voice output 240 that outputs the recorded voice, an image capturing device 250 that captures an image of a user, such as an image of the user's palm, an angular speed sensor 260 and an acceleration sensor 270 that detect movement of the mobile terminal 20, a communication module 280 that wirelessly communicates with the indoor device 10, a GPS module 290 that confirms a location of the mobile terminal 20, and a memory 295 that stores various information and data. The mobile terminal 20 may be the recently introduced smart phone, and may have, for example, a phone call function, an Internet access function, a program download function, and a one-to-one or direct communication function.

The key input 210 may include an input button or a touch panel provided in or on the mobile terminal 20, the image capturing device 250, which may include a camera mounted on the mobile terminal 20, the voice input 230, which may include a recorder mounted on the mobile terminal 20, and the voice output 240, which may include a speaker mounted on the mobile terminal 20.

The angular speed sensor 260 may include a Gyro sensor or Gravity sensor that detects inclination or a rotation angle of the mobile terminal 20. The acceleration sensor 270 may be a sensor that detects a speed or acceleration of the mobile terminal 20 as it linearly moves in a particular direction.

The communication module 280 may include, for example, a Bluetooth module, a Wi-Fi module, or a ZigBee module, as mentioned above. The display 220 may include, for example, a liquid crystal panel provided in the mobile terminal 20.

The indoor device 10 may include a controller 100, a key input 110, a voice input 130, a voice output 140, an image capturing device 150, a display 120, a communication module 180, and a memory 170. The indoor device 10 may further include a driver 160 that drives a fan 161, a compressor 162, and a wind direction adjustment device 163 mounted in the indoor device 10. The driver 160 may include a motor driver that controls current amounts supplied to a drive motor that drives the fan 161, the compressor 162, and the wind direction adjustment device 163.

The image capturing device 150, the voice input 130, the voice output 140, the display 120, and the communication module 180 may be the same as or similar to the image capturing device 250, the voice input 230, the voice output 240, the display 220, and the communication module 280 of the mobile terminal 20, and thus, a detailed description thereof has been omitted.

As shown, the mobile terminal 20 and the indoor device 10 may independently receive information from the Internet or transmit and receive information from each other, through the communication modules 280, 180. The mobile terminal 20 and the indoor device 10 may download, for example, weather and product information of the indoor device 10 by an Internet connection through the communication module 280. In addition, the indoor device 10 may also access the Internet through the communication module 180. For example, the mobile terminal 20 may perform Internet access through a Wi-Fi communication module, using as an access point the wire and wireless router 1 or the wireless router 2. Also, the mobile terminal 20 may receive and transmit information from or to the indoor device 10. This is called infra-structure networking.

In addition, the mobile terminal 20 and the indoor device 10 may perform peer to peer communication using the communication modules 180, 280. For example, when the communication modules 180, 280 are Wi-Fi modules, the communication may be directly performed through Wi-Fi direct networking or Ad-Hoc networking, without going through the wireless router.

In more detail, Wi-Fi direct means a technology that can communicate using a communication standard, such as 802.11a, b, g, n, by high-speed, regardless of the installation of a wireless LAN access device (AP: Access point). That is, it means that the mobile terminal 20 may communicate with the indoor device 10 wirelessly without going through the wireless LAN device (Access Point), i.e., the wire and wireless router or the wireless router as described above. This technology has recently been in the spotlight as a communication technology that can connect an indoor device and a mobile terminal to each other wirelessly without using an Internet network.

The Ad-hoc network (or Ad-hoc mode) is a network that can only communicate using a mobile host without having a fixed wire network. Accordingly, since movement of the host is not restricted, and a wired network and a base station is not required, resulting in faster and cheaper network configurations. That is, the wireless communication between wireless terminals may be possible without the need for the wireless LAN access device (AP). Accordingly, in an Ad-hoc mode, the mobile terminal 20 may communicate with the indoor device 10 wirelessly without the need for a wireless LAN access device.

Bluetooth technology is already well known as a short range wireless communication method. With Bluetooth technology, wireless communication may be possible within a certain range through a pairing process between a Bluetooth module built into the mobile terminal 20 and a Bluetooth module built into the indoor device 10. In the same way as the Bluetooth communication, one-to-one communication is also possible using ZigBee pairing.

The smart meter 30 may receive and transmit data from and to the mobile terminal 20 or the indoor device 10 through the wireless communication method, as discussed above.

In the following description, a method in which an image of a user, such as an image of a user's palm, may be recognized and captured using an image capturing device included in an indoor device, such as the indoor device 10 of FIG. 1-2, a movement trajectory of the captured user image tracked, and the operating condition(s) extracted from different types of the obtained trajectory, will be described with reference to a flow chart.

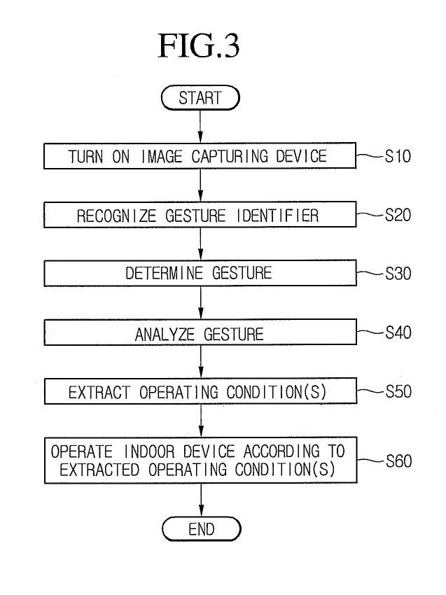

FIG. 3 is a flow chart of a method for controlling an indoor device of an air conditioning apparatus by detecting a gesture identifier, such as a gesture of a user's hand or palm, according to an embodiment. Referring to FIG. 3, first, when a user raises his/her hand or palm in front of an indoor device, such as the indoor device 10 of FIGS. 1-2, the indoor device may recognize the user' palm and turn on the image capturing device 150. As a method of recognizing the user' palm, the following examples are provided.

First, a detection sensor 185 may be mounted on or to a front of the indoor device and may detect a user, such as a palm of the user when the user raises his/her hand. The detection sensor 185 may be, for example, a human detection sensor or a common infrared sensor (Infra-red sensor) including a PIR sensor (passive infra-red sensor). When the detection sensor 185 detects the user, the image capturing device 150 may be turned on so that the image capturing device 150 may be ready to capture an image.

Second, the image capturing device 150 may always be turned on, so that the image capturing device 150 may capture an image every certain time period, for example, every approximately 0.2 seconds, and determine whether the user's palm enters within a frame of the image capturing device 150, by comparing a current frame with a previous frame of the captured images. A method for determining the presence or movement of an object by comparing images can determine the presence or movement of an object using an image difference comparing method comparing a previously captured image (frame 1) and a currently captured image (frame 2).

In more detail, the image difference comparing method is a method that identifies a movement of a subject for which images of the subject are captured, and calculates differences between the captured images. An image difference frame excluding a common area, in which no pixels change, is obtained by calculating differences in the previously captured image and the currently captured image. The method may determine whether moving or movement of the subject occurs by analyzing the captured image difference frame. Such image difference comparing methods are well known to those skilled in the art, and thus, detailed explanation thereof has been omitted. With this embodiment, movement of a subject may be determined through a comparison analysis of a plurality of images continuously captured by the image capturing device to determine whether the user or an appendage of the user, for example, the user's palm is in front of the indoor device.

When it is recognized that the user's palm is in front of the indoor device and the image capturing device 150 is turned on, as described above, the image capturing device 150 may capture an image of the user's palm at regular intervals. In addition, the image capturing device 150 may perform a recognition process that recognizes a gesture identifier using the captured image, in step S20.

In the recognition of the gesture identifier, it is determined whether the captured image includes an object in the shape of a palm by analyzing the image captured by the image capturing device 150. When the gesture identifier is recognized and the user moves his or her palm in a specific direction, a gesture input process is performed to determine and input a gesture, in step S30.

When the user moves his/her palm in front of the indoor device 10, within an image frame captured by the image capturing device 150, in a specific direction, the movement shape of the palm is captured using a continuous image capturing process by the image capturing device 150, and the movement shape of the palm may be stored in a controller, such as the controller 100 of FIGS. 1-2.

In addition, when the gesture determination and input has been completed, the controller, such as the controller 100 of the indoor device 10 of FIGS. 1-2, may perform a gesture analysis process using a gesture analysis program, in step S40. Further, a movement trajectory of, for example, the user's palm, may be extracted using the gesture analysis process, and an operating condition or conditions may be extracted according to or based on a shape of the extracted movement trajectory, in step S50. Operation of the indoor device 10 may be performed according to the extracted operating condition or conditions.

Hereinafter, a gesture input process and gesture analysis process will be described in detail.

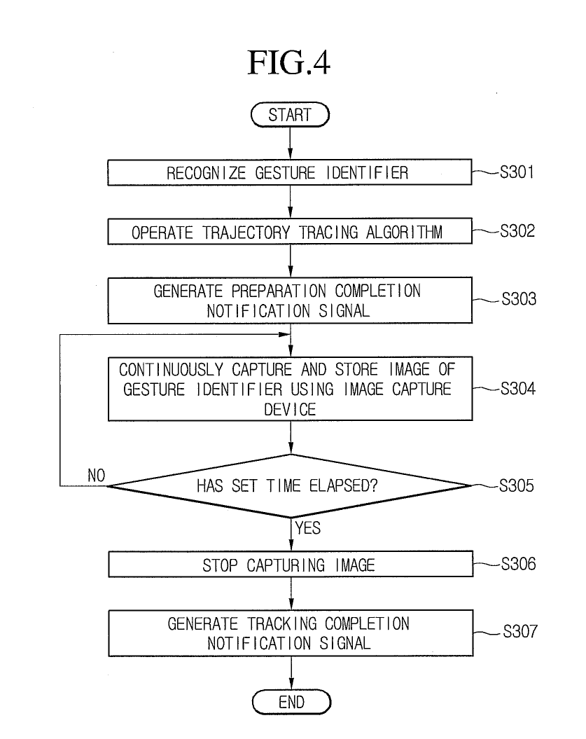

FIG. 4 is a flow chart of a gesture input process according to the embodiment. Referring to FIG. 4, a gesture identifier of a user, for example, a user's palm or hand, may be recognized by a detection sensor, as described with respect to in FIG. 3, or through real-time continuous image capturing by an image capturing device, such as the image capturing device 150 of FIGS. 1-2, in step S301.

When the user's palm or hand, for example, is recognized as a gesture identifier, a trajectory tracking algorithm may be operated in the controller, such as controller 200 of the indoor device 10 of FIGS. 1-2, in step S302. When the trajectory tracking algorithm is operated, a notification signal that the image capturing device, such as the image capturing device 150 of FIGS. 1-2, has been readied to track the movement of the user's palm may be generated, in step S303. The notification signal may include, for example, specific types of sound signals, lights, text massages, or avatar images. That is, any type of signal that a user may recognize as a preparation complete signal is permissible.

When the preparation completion signal has been generated, the user may move the gesture identifier, for example, his or her palm in a specific direction. Even though a range of movement of the gesture identifier, for example, the user's palm, may be defined within a frame of the image capturing device, such as the image capturing device 150 of the indoor device 10 of FIGS. 1-2, because the frame is larger as the gesture identifier is moved farther away from the image capturing device, there is little chance that the gesture identifier will be moved beyond or outside of the frame.

The image capturing device 150 may continuously capture an image of the gesture identifier, for example, the user's palm, at regular intervals, starting from the preparation completion time, in step S304, and tracking of the palm trajectory may be possible using the gesture analysis process. For example, the image capturing device may continuously capture an image every approximately 0.2 seconds. In addition, the captured palm image may be stored in a memory, such as the memory 170 of FIGS. 1-2.

The controller, for example, the controller 100 of the indoor device 10 of FIGS. 1-2, may detect the movement of the gesture identifier, for example, the user's palm, through image analysis using the image difference comparison method of the captured images. That is, it may be determined that the gesture identifier, for example, the user's palm, has stopped or moved. When movement is detected, through the image comparison process, it may be determined whether a predetermined stop time has elapsed, in step S305. This is intended to determine whether input of a control command has been completed through the movement of the gesture identifier, for example, the user's palm. That is, after determining that a movement of the gesture identifier, for example, the user's palm, corresponding to a specific control command begins and ends at any time, a movement trajectory of the gesture identifier, for example, the user's palm, may be extracted.

Meanwhile, when the movement of the gesture identifier, for example, the user's palm, is stopped and the set time has elapsed, the image capturing device by the image capturing device may be stopped, in step S306. At the same time or sequentially, a notification signal indicating that tracking of the gesture identifier, for example, the user's palm, has been completed may be output, in step S307. The notification signal may be the same signal as the preparation completion signal, as discussed with respect to step S303.

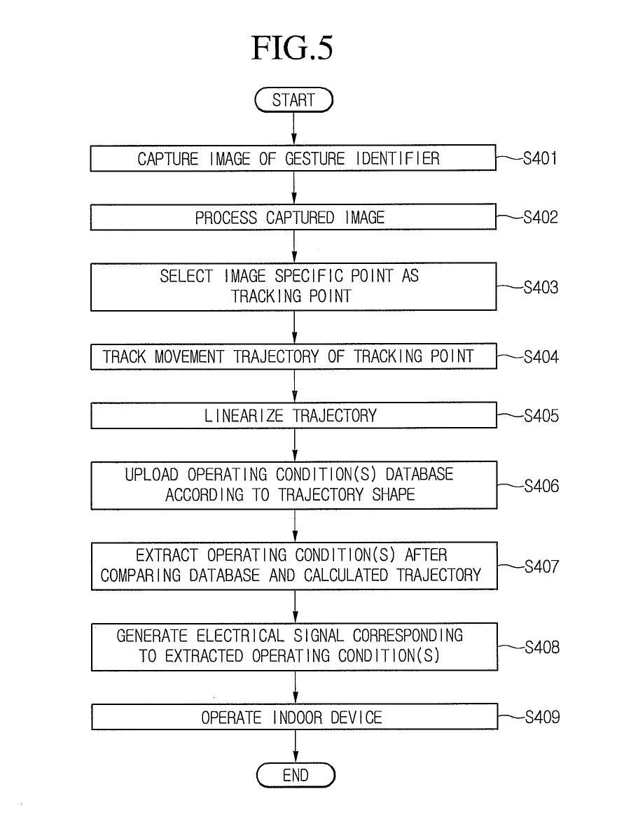

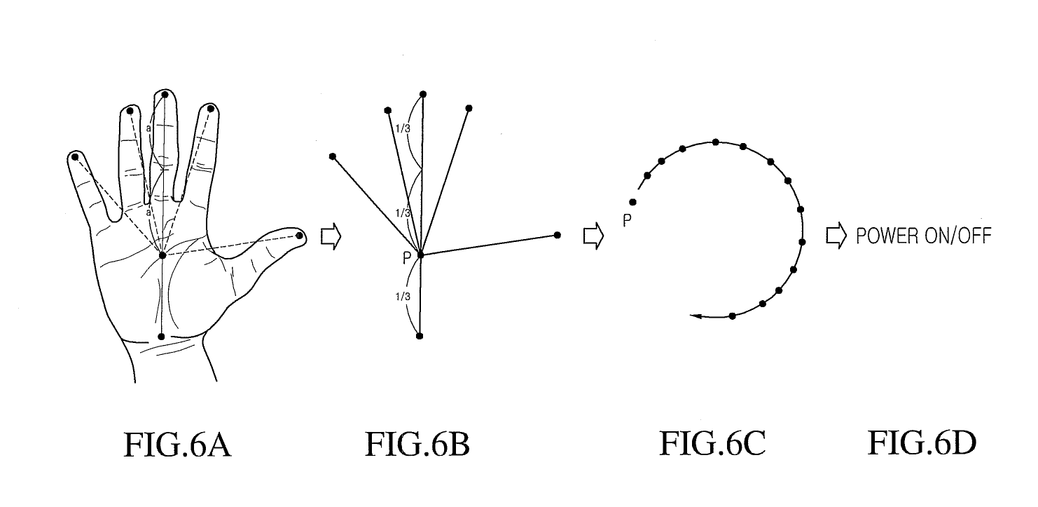

FIG. 5 is a flow chart of a gesture analysis process according to an embodiment, and FIGS. 6A-6D are explanatory diagrams visually illustrating the gesture analysis process of FIG. 5. The results obtained for each step of the analysis performed as discussed with respect to FIG. 5 are shown in FIG. 6. Accordingly, FIG. 6 will be described while describing the method of FIG. 5.

Referring to FIG. 5, an image of the gesture identifier, for example, the user's palm, may be captured in a gesture input process, in step S401, and an image processing process may be performed, in step S402. The image of the gesture identifier, for example, the user's palm, may be captured and an image processing process of the captured image may be performed, as shown in FIGS. 6A and 6B.

In more detail, on the captured user's palm image, an image processing process representing simplified finger images is performed by taking points extending between a center of the palm and an end of each finger and a bottom of the palm. The image processing process of FIGS. 6A and 6B is defined as a linearization operation. The palm image is converted into a simplified image including a plurality of lines.

Next, a process for selecting a specific point of the linearized palm image as a tracking point is performed, in step S403. For example, a point selected on a tip of a middle finger and a point selected on a lowest point of the palm may be connected by a straight line, and the straight line may be divided into several parts (i.e. three even parts in the drawing). Any one point of a plurality of points of the divided several parts may be selected as a tracking point (P). Further, when points selected on the tips of the fingers are connected to the tracking point (P), the form may be converted into that shown in FIG. 6B. For example, as shown in FIG. 6B, a point, which is at a one-third point on the straight line starting from the lowest point of the palm, may be selected as the tracking point (P).

When the image linearization operation has been completed, a process for tracking the movement trajectory of the tracking point (P) may be performed, in step S404. In more detail, all of the captured images may be linearized until movement of the palm starts and stops, and then a process, by which the tracking point may be extracted and a trajectory linearized by connecting the extracted point by a line, may be performed, in step S405. Then, a form of tracking point (P), as shown in FIG. 6C, may be obtained. The number of tracking points connected to each other may be equal to a number of frames of the captured user's palm image.

The linearized trajectory may be transmitted to the controller, such as the controller 100 of the indoor device 10 of FIGS. 1-2 and a database in which the operating condition(s) may be set according to trajectory forms, may be uploaded from a memory, such as the memory 170 in the controller 100, of FIGS. 1-2, in step S406. In addition, operating condition(s) may be extracted by comparing the calculated trajectory and the database, in step S407. Further, electrical signals corresponding to the extracted operating condition(s) may be generated in the controller, in step S408, and the driving of the indoor device may be initiated according to the generated electrical signals, in step S409.

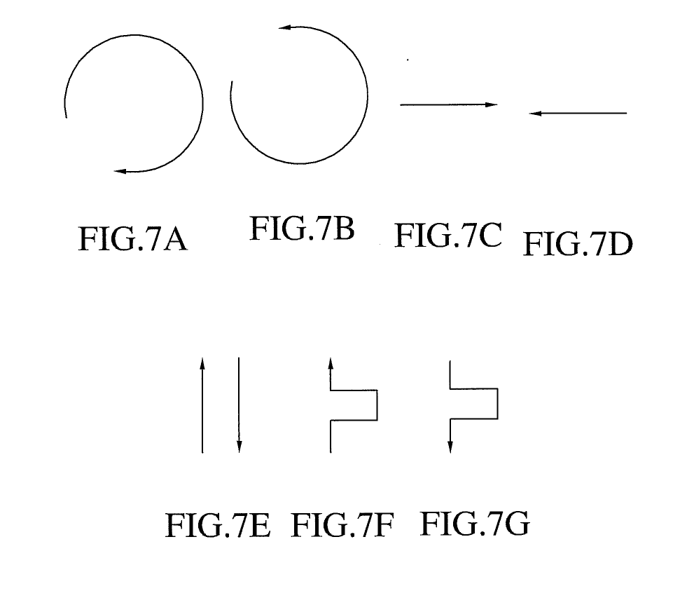

FIGS. 7A to 7G are diagrams illustrating exemplary shapes of a gesture identifier, for example, the user's palm, trajectory for operating condition(s) in a method of controlling an indoor device according to an embodiment. Referring to FIG. 7, the database may store a specific form of trajectory for each operating condition or conditions in the form of a look up table. For example, an operating condition or conditions corresponding to a form of a trajectory rotated clockwise, as shown in FIG. 7A, may be set corresponding to a specific operating command, and an operating condition or conditions corresponding to the form of trajectory rotated counterclockwise, as shown in FIG. 7B, may be set corresponding to a specific operating command.

In addition, as shown in FIGS. 7C, 7D and 7E, left wind, right wind, or up wind and down wind may be set depending on the arrow direction. That is, a wind adjustment device may be set to be rotated in left and/or right directions or up and/or down directions by a set angle every time a command generated by moving the trajectory in the left and/or right direction, or the up and/or down direction is input once.

In addition, as shown in FIGS. 7F and 7G, a trajectory form in which the trajectory is in the form of a winding meander line may be set as an operating condition of wind amount increase or wind amount decrease, respectively. That is, as shown in FIG. 7F, when the trajectory is a form to increase wind, the operating condition may be set as a wind amount increase, and when the trajectory is a form to decrease, the operating condition(s) may be set as a wind amount decrease. That is, the amount may be increased or decreased by a set amount every time the command is input once.

Here, it is noted that a form of trajectory corresponding to the operating condition(s) for changing the wind direction or the wind amount may be in various forms in addition to the forms shown. In addition, the forms of the trajectory may be set as those corresponding to the operating condition for indoor temperature or indoor humidity, as well as wind direction or wind amount.

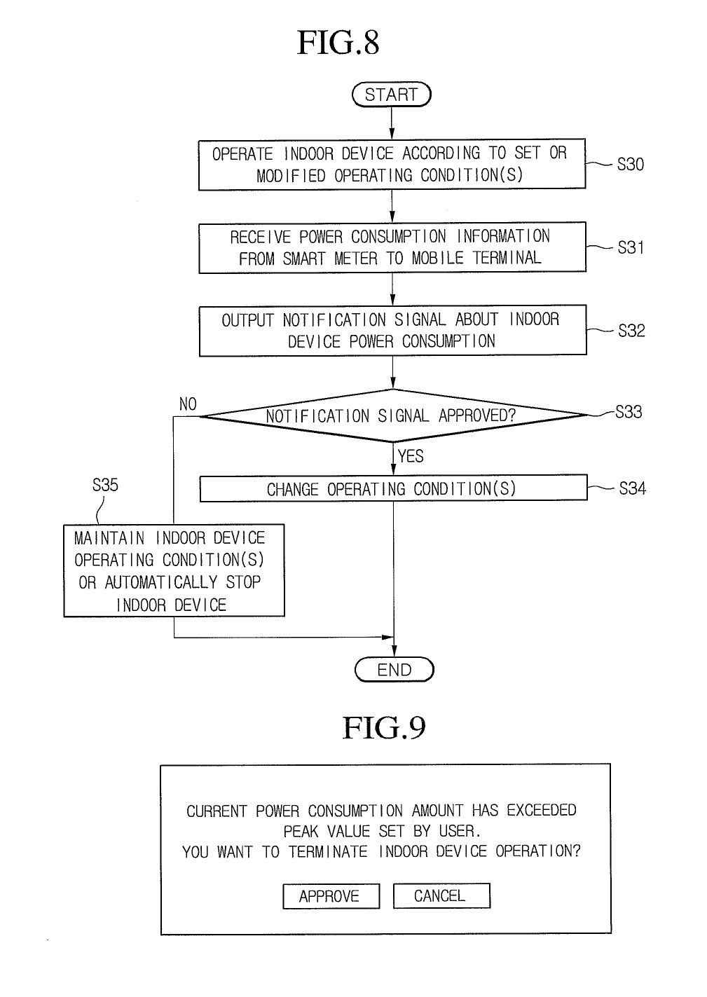

FIG. 8 is a flow chart of a method for controlling an indoor device, based on power amount information received from a smart meter according to an embodiment. Referring to FIG. 8, in this embodiment, a variable for setting the operating condition of the indoor device may further include power amount information received from a smart meter, in addition to an operating condition or conditions selected by movement of, for example, a gesture identifier, for example, the a user's palm.

In more detail, according to the control method described with respect to FIG. 8, in a state in which the indoor device is operated, in step S30, the mobile terminal, such as mobile terminal 20 of FIGS. 1-2, may receive power amount information received from a smart meter, such as smart meter 30 of FIGS. 1-2, in step S31. The power consumption information may include charges per watt of power at a current time, a power consumption amount at a current time, electricity charges for power consumption, and a maximum allowable power consumption amount set by a user. Hereinafter, the maximum allowable power consumption amount may be defined and described as a peak value.

Meanwhile, a notification signal about the current power consumption of the indoor device may be output through the mobile terminal or the indoor device, based on consumption information transmitted from the smart meter, in step S32. The notification signal may mean a warning signal informing the user of a state in which current power consumption is close to a peak value or exceeds the peak value, to change the operating state of the indoor device when power charges per watt may be maximum at a current time when the indoor device is operated.

A method for displaying the notification signal on the mobile terminal or the indoor device may include warning alarms, warning lights, characters, or avatar forms on a screen of the mobile terminal or the indoor device. In addition, the display, for example, a screen of the mobile terminal or the indoor device, may display a message confirming whether any changes proposed through the notification signal are approved. In addition, a process for determining whether the changes are approved by the user may be performed, in step S33. That is, when the changes proposed through the notification signal are approved by the user, the operating condition(s) of the indoor device may be changed, in step S34. However, when the changes proposed through the notification signal are not approved by the user, previously input operating condition(s) may be maintained, or the indoor device may be automatically stopped, in step S35. The types of the notification signal will be described hereinbelow.

When information transmitted from the smart meter is used as an additional variable, the operation of the indoor device may be operated economically, and accordingly, power consumption may be reduced.

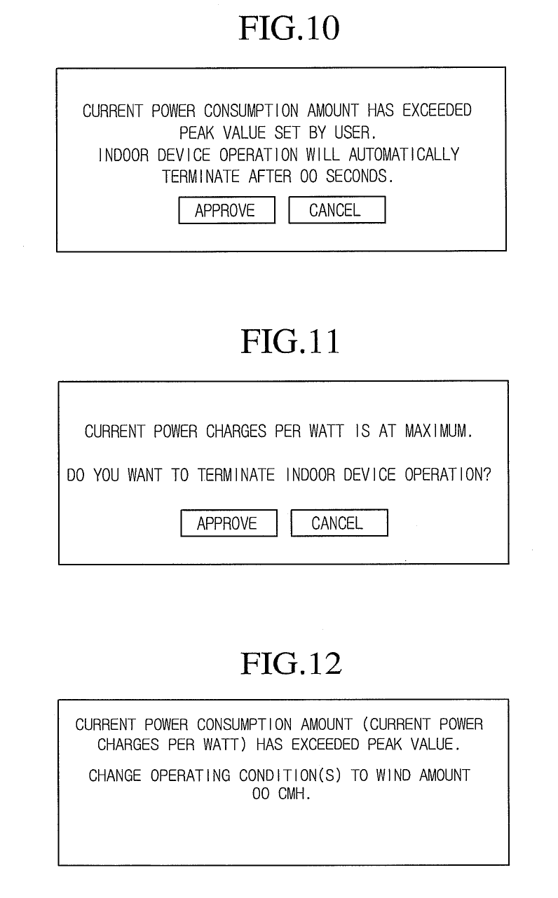

FIGS. 9 to 12 are diagrams illustrating contents of a notification signal output based on information transmitted from a smart meter according to an embodiment. The contents shown in FIG. 9 require a change in the operating condition(s) of the indoor device when the current power consumption is close to a peak value or exceeds the peak value set by the user. The notification signal may be output on a screen of the mobile terminal or the indoor device, and when an approval is entered by the user, operation of the indoor device may be terminated. In contrast, when an approval is not entered by the user, the operating condition(s) of the indoor device may be maintained.

The contents shown in FIG. 10 require a change in the operating condition(s) of the indoor device when power charges per watt unit at a current time are maximal. As shown, when power charges per watt unit at the current time are maximal, termination of the operation of the indoor device may be performed, and when approval is entered by the user, operation of the indoor device may be terminated.

The contents shown in FIG. 11 require a change in the operating condition(s) of the indoor device to operating condition(s) of lower power consumption when the current power consumption has reached or exceeded a peak value or where power charges per watt unit at a current time are maximal. When the recommendation is approved by the user, the operating condition(s) are changed to those recommended by the controller of the indoor device or mobile terminal, and when the recommendation is not approved, the previous operating condition(s) may be maintained.

The contents shows in FIG. 12 terminate operation of the indoor device by force according to the controller of the indoor device 10 or the mobile terminal, not by user selection. That is, operation of the indoor device may be terminated by force regardless of the intention of the user when the current power consumption has reached or exceeded the peak value or where power charges per watt unit at a current time are maximal. In this case, the process confirming approval by the user may not be required. The automatic stopping of the indoor device 10 of FIG. 8 may be considered as a case in which the notification signal is output.

A method for controlling an air conditioning apparatus according to embodiments has at least the following advantages.

First, operation of the air conditioning apparatus may be controlled using a mobile terminal, even when a wireless remote controller configured to receive input operating condition(s) for the air conditioning apparatus is lost or damaged.

Second, a risk of loss is lower due to the nature of the mobile terminal. That is, a location of the mobile terminal may be confirmed by making a phone call to the mobile terminal, when the mobile terminal is unable to be found.

Third, the inconvenience of replacing a battery of the remote controller may be eliminated, since the air conditioning apparatus may be controlled by the mobile terminal.

Fourth, ease of use may be increased since the indoor device may be controlled by only moving a gesture identifier, such as a raised user's palm, in front of the indoor device.

Fifth, power consumption may be reduced since the operating condition(s) may be changed by receiving power rates information from a smart meter.

Embodiments disclosed herein provide a control method of an air conditioning apparatus capable of remotely controlling an indoor unit or device by an operation of moving a part of the user's body in the front of the indoor unit.

More specifically, embodiments disclosed herein provide a control method of the indoor unit or device capable of controlling, for example, a direction of wind, an amount of wind, or a temperature of the indoor unit by an operation of moving a raised user's palm.

Embodiments disclosed herein provide a control method of an air conditioning apparatus that may include turning on a photographing unit or image capturing device provided in an indoor unit or device; recognizing a gesture identifier accessed or moved into a front area of the photographing unit; inputting a gesture according to a movement of the gesture identifier; analyzing the input gesture; extracting operating condition(s) corresponding to the analyzed gesture; and driving the indoor unit according to the extracted operating condition(s).

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A method for controlling an air conditioning apparatus, the method comprising:
recognizing a gesture identifier at a front area of an image capturing device provided in an indoor device of the air conditioning apparatus;
determining a gesture according to a movement of the gesture identifier;
analyzing the determined gesture;
extracting at least one operating condition corresponding to the analyzed gesture; and
operating the indoor device according to the extracted at least one operating condition.

2. The method according to claim 1, further comprising:
turning on the image capturing device.

3. The method according to claim 2, wherein the image capturing device is turned on when the gesture identifier is detected by a detection sensor provided in or on the indoor device.

4. The method according to claim 1, wherein the image capturing device is continuously maintained in a turned-on state regardless of a presence or absence of the gesture identifier.

5. The method according to claim 1, wherein the recognizing of the gesture identifier is performed by comparing image differences between a plurality of images captured in series by the image capturing device.

6. The method according to claim 1, wherein the determining the gesture includes:
capturing in series a plurality of images of the gesture identifier; and
sequentially storing the plurality of images.

7. The method according to claim 6, wherein the analyzing the determined gesture includes:
selecting specific points on the plurality of captured images of the gesture identifier, respectively, as tracking points; and
linearizing the tracking points by connecting a movement path of the selected tracking points.

8. The method according to claim 7, wherein the extracting the at least one operating condition includes:
uploading a preset database of operating conditions corresponding to a shape of the movement path of the tracking points;
comparing the shape of the movement path of the tracking points completed by linearization to shapes stored in the database; and
determining at least one operating condition corresponding to the shape of the movement path of the tracking points.

9. The method according to claim 8, wherein the database is stored in the form of a look-up table.

10. The method according to claim 1, wherein the gesture identifier is a user's palm.

11. The method according to claim 1, further comprising generating a notification signal at an input preparation completion time and at an input completion time, respectively.

12. The method according to claim 11, wherein the notification signal includes at least one of sound, light, characters, or avatars.

13. The method according to claim 1, further comprising receiving power information including at least one of an amount of power consumption, a power charge per watt, or a peak value of power consumption into the indoor device.

14. The method according to claim 13, further comprising generating a notification signal requiring an approval by the user for change of the extracted at least one operating condition, based on the received power information.

15. The method according to claim 14, wherein the operating of the indoor device is automatically stopped after generating the notification signal.

16. The method according to claim 14, wherein when the approval for change of the at least one operating condition is performed, the at least one operating condition of the indoor device is changed according the approval by the user from the extracted at least one operating condition to a new at least one operating condition.

17. The method according to claim 14, wherein when the approval for change of the at least one operating condition is not performed, a wind volume condition of the indoor device is maintained as the extracted at least one operating condition.

18. The method according to claim 14, wherein the notification signal includes at least one of sound, light, characters, or avatars.

19. An air conditioning apparatus, comprising:
means for recognizing a gesture identifier at a front area of an image capturing device provided in an indoor device of the air conditioning apparatus;
means for inputting a gesture according to a movement of the gesture identifier;
means for analyzing the determined gesture;
means for extracting at least one operating condition corresponding to the analyzed gesture; and
means for operating the indoor device according to the extracted at least one operating condition.

20. An air conditioning apparatus, comprising:
a sensor that detects a gesture identifier at a front area of an indoor device of the air conditioning apparatus;
an image capturing device configured to capture one or more images of the gesture identifier; and
a controller configured to recognize the gesture identifier, determine a gesture according to a movement of the gesture identifier, analyze the determined gesture, extract at least one operating condition corresponding to the analyzed gesture, and operate the indoor device according to the extracted at least one operating condition.

21. The air conditioning apparatus according to claim 20, further comprising:
a memory, wherein the image capturing device captures in series a plurality of images of the gesture identifier, which are serially stored in the memory.

22. The air conditioning apparatus according to claim 21, wherein the controller recognizes the gesture identifier by comparing differences between the plurality of image captured in series.

23. The air conditioning apparatus according to claim 22, wherein the controller selects specific points on the plurality of captured images of the gesture identifier, respectively, as tracking points, and linearizes the tracking points by connecting a movement path of the selected tracking points.

24. The air conditioning apparatus according to claim 23, wherein the controller extracts at least one operating condition corresponding to the analyzed gesture by uploading a preset database of operating conditions corresponding to a shape of the movement path of the tracking points, comparing the shape of the movement path of the tracking points completed by linearization to shapes stored in the database, and determining at least one operating condition corresponding to the shape of the movement path of the tracking points.

25. The air conditioning apparatus according to claim 24, wherein the database is stored in the memory form of a look-up table.

26. The air conditioning apparatus according to claim 20, wherein the gesture identifier is a user's palm.

27. The air conditioning apparatus according to claim 20, wherein the controller is configured to receive power information including at least one of an amount of power consumption, a power charge per watt, or a peak value of power consumption into the indoor device from a smart meter, and generate a notification signal requiring an approval by the user for change of the extracted at least one operating condition, based on the received power information.

28. The air conditioning apparatus according to claim 27, wherein the notification signal includes at least one of sound, light, characters, or avatars.
